(19) United States
(12) Patent Application Publication
(10) Pub. No.: US 2006/0096832 A1
(43) Pub. Date: May 11, 2006

(54) Separator plates and manufacturing method for the same

(75) Inventor: Yukihiko Ito, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: NSK-WARNER KABUSHIKI KAISHA

(21) Appl. No.: 11/269,558

(22) Filed: Nov. 9, 2005

(30) Foreign Application Priority Data
Nov. 10, 2004 (JP) P. 2004 - 326950

(51) Int. Cl. F16D 13/52

(52) U.S. Cl. 192/70.2

(57) ABSTRACT

Waves in which fine recesses and projections extend continuously along root circles Y of spline teeth 72 formed on an outer circumferential surface 73 of a separator plate 7 are formed. A reference numeral 76 denotes a recessed portion of the separator plate. A distance W between the teeth is set larger than the width T of one tooth. A fluid film is formed in the recessed portion formed by the waves in an initial period in the time of engagement of the clutch. As a result, a friction coefficient in the initial period of the time of engagement of the clutch decreases, and friction characteristics thereof are improved. During the manufacturing of the separator plate, a circumferential surface 74 not having spline teeth is stamped out, and spline teeth 72 of an outer circumferential surface 73 thereafter.

The present invention claims foreign priority to Japanese patent application No. P.2004-326950, filed on Nov. 10, 2004, the contents of which is incorporated herein by reference.

### BACKGROUND OF THE INVENTION

1. Field of the Invention

The present invention relates to separator plates for a wet type multiple disc clutch which are used for automatic transmissions and the like, having a reduced friction coefficient in an initial period of an engagement the clutch.

2. Description of the Background Art

FIG. 1 is a sectional view conceptually showing the basic construction of a wet type multiple disc clutch 10. A plurality of separator plates 7 and friction plates 8 are arranged alternately between a clutch case 1 and a hub 4. The separator plates 7 are fitted to a spline portion 11 of the clutch case 1, and the friction plates 8 are fitted to a spline portion 41 of the hub 4.

In order to engage in the clutch, a hydraulic pressure is introduced into a fluid chamber 3 formed between the clutch case 1 and piston 2. As a result, the piston 2 is pressed leftward in FIG. 1 to push the separator plates 7 and friction plates 8 toward a stop ring 5 and a backing plate 6, whereby torque is transmitted between the clutch case 1 and hub 4. In order to release the clutch, the hydraulic pressure is removed from the fluid chamber 3. As a result, a piston returns rightward owing to a spring 9, and the clutch is released. Referring to the drawing, a line X-X denotes a center line of the clutch 10.

FIG. 2 is a plan view of a separator plate 7. In FIG. 2, a reference numeral 71 denotes a frictional engagement surface of the plate made of metal, 72 denotes a spline teeth formed on an outer circumferential surface thereof, and 74 denotes an inner circumferential surface which is formed after an inner circumferential portion 75 was stamped out.

FIG. 3 is a plan view of the friction plate 8. In FIG. 3, a reference numeral 81 denotes a core plate made of metal material, 82 denotes a friction member pasted on an outer surface of the core plate, and 83 denotes a spline teeth formed on an inner circumferential surface (in the case of the embodiment shown in FIG. 1) of the core plate.

In such the clutch, both the separator plate and the friction plate are formed flat plates. Therefore, when the clutch is engaged, quantity of the fluid supplied under pressure among the plates is not so large, so that the friction coefficient in an initial period of the engagement of the clutch becomes high. This causes a biting shock to occur in some cases.

As referred to above, in the above-described wet type multiple separator plate, the friction coefficient in the initial period of the engagement of the clutch is high. Therefore, when a large transmission torque is imparted suddenly to the clutch, undesirable friction characteristics such as the so-called biting shock and the like occur in some cases.

### SUMMARY OF THE INVENTION

In order to solve the above described problems, one of objects of the present invention is to obtain separator plates for a wet type multiple disc clutch, adapted to eliminate these drawbacks, reduce a friction coefficient in an initial period of the time of the engagement of the clutch, alleviate a shock occurring in a speed changing operation of an automatic transmission, improve the friction characteristics and control the actions of the clutch easily; and a manufacturing method for the same.

In order to solve the problems, according to a first aspect of the present invention, there is provided a separator plate for wet type multiple disc clutches, comprising:

a ring-shaped plate having an inner circumferential surface and an outer circumferential surface; and

pluralities of spline teeth formed on either the outer circumferential surface or the inner circumferential surface of the plate,

wherein a distance defined between adjacent spline teeth is set not smaller than a width of at least one spline tooth,

a wave is formed by fine recesses and projections projecting in a direction perpendicular to the plate, and

the wave extends continuously along a root circle defined by the spline teeth.

According to a second aspect of the present invention, as set forth in the first aspect of the present invention, it is preferable that a depth in the direction perpendicular to the plate, which is defined by the recesses and the projections of the waves, is 10 to 40 μm.

According to a third aspect of the present invention, there is provided a manufacturing method for a separator plate for wet type clutches comprising pluralities of spline teeth formed on an inner circumferential surface or an outer circumferential surface of the separator plate, the manufacturing method comprising the steps of:

stamping out a non-spline-tooth-formed portion of the separator plate which is an opposite side of a spline-tooth-formed inner circumferential surface thereof or a spline-tooth-formed outer circumferential surface thereof; and

stamping out the spline tooth-formed portion to thereby form a wave, which is formed by fine recesses and projections, extend continuously along a root circle of the spline tooth after stamping out the non-tooth-formed portion.

Owing to this invention, the friction coefficient in the initial period of the clutch-engaged time decreases. As a result, the shock occurring during a speed changing operation of the automatic transmission is alleviated, and the controlling of the operation of the wet type multiple disc clutch becomes easy, the friction characteristics thereof being thereby improved.

### BRIEF DESCRIPTION OF THE DRAWINGS

FIG. 1 is a sectional view showing the construction of the wet type multiple disc clutch;

FIG. 2 is a plan view of a separator plate;

FIG. 3 is a plan view of a friction plate;

FIG. 4 is a plan view a separator plate according to the present invention;

FIG. 5 is a sectional view taken along the line V-V in FIG. 4;

FIG. 6 is a sectional view taken along the line VI-VI in the same drawing;

FIG. 7 is a drawing showing the order of stamping a material;

FIG. 8 is a conceptual drawing showing how to punch a material; and

FIG. 9 is a diagram showing the relation between the depth of waves and transmission torque.

### DETAILED DESCRIPTION OF THE PREFERRED EMBODIMENTS

Each separator plate according to the present invention has waves, which is formed by fine recesses and projections, extend along a root circles of the spline teeth formed on either the inner circumferential surface or the outer circumferential surface of the plate. The moment the frictional engagement of the clutch is started, fluid film is formed in recessed portions of the waves, so that a suitable level of slide of the separator plate occurs with respect to an opposed member, such as the friction plate in the initial period of the frictional engagement of the clutch, whereby excellent frictional characteristics is obtained. The depth of the recess in the waves is preferably around 10 to 40 μm. When a distance between adjacent spline teeth is set larger than the width of one tooth, the shape of the teeth suitable for the formation of the waves is obtained.

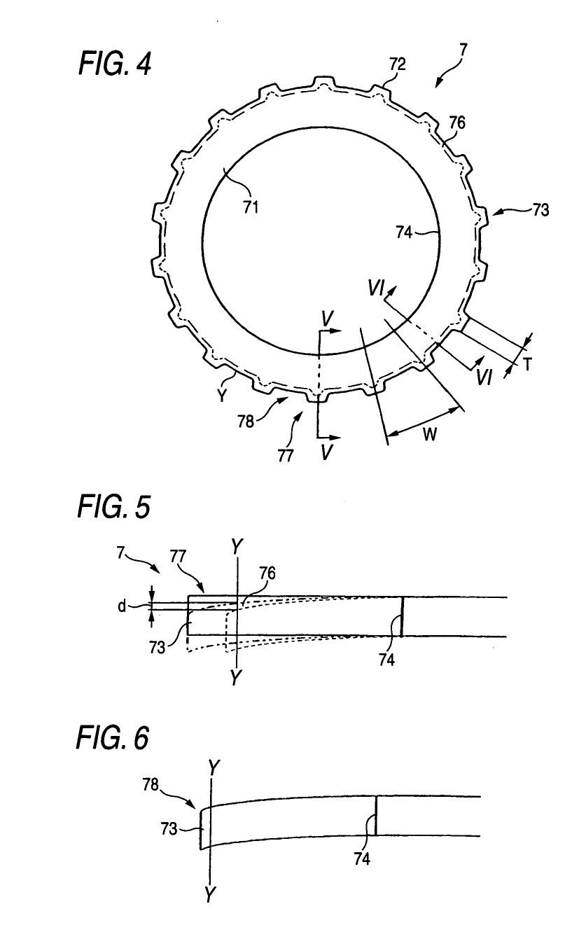

FIG. 4 shows an embodiment of the present invention, which is a plan view of a separator plate 7 on an outer circumferential surface 73 on which spline teeth 72 are formed. A reference numeral 71 denotes a frictional engagement surface of the separator plate 7, 72 denotes spline teeth formed on the outer circumferential surface 73, and 74 denotes an inner circumferential surface formed after an inner circumference-forming portion was stamped out.

In each separator plate 7 according to the present invention, a distance W defined between adjacent spline teeth is set larger than the width T of one tooth 72.

FIG. 5 is a sectional view taken along the line V-V in FIG. 4, and FIG. 6 a sectional view taken along the line VI-VI. The recesses 76 are formed along root circles of the spline teeth 72. FIG. 5 shows each root circle by a reference letter “Y”. As understood from the drawing, the recesses 76 form waves having fine recesses and projections extend continuously. When the root circle Y is taken on an enlarged scale, owing to their flexure, a difference d is formed between an end of a non-tooth-formed portion 78 and an end of a tooth-formed portion 77 in the depth direction. A part of the separator plate between the teeth forms a recessed portion of the waves.

The moment the frictional engagement of the clutch is started, a fluid film is formed in the recessed portions, and a suitable slide occurs with respect to opposed members in the initial period in the time of the frictional engagement of the clutch, so that excellent frictional characteristics come to be obtained.

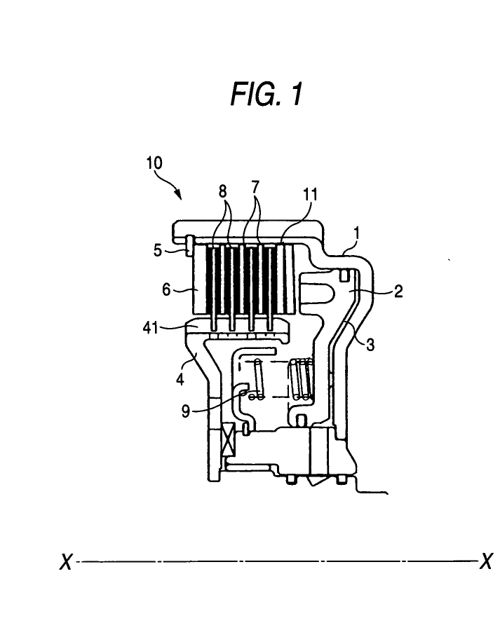

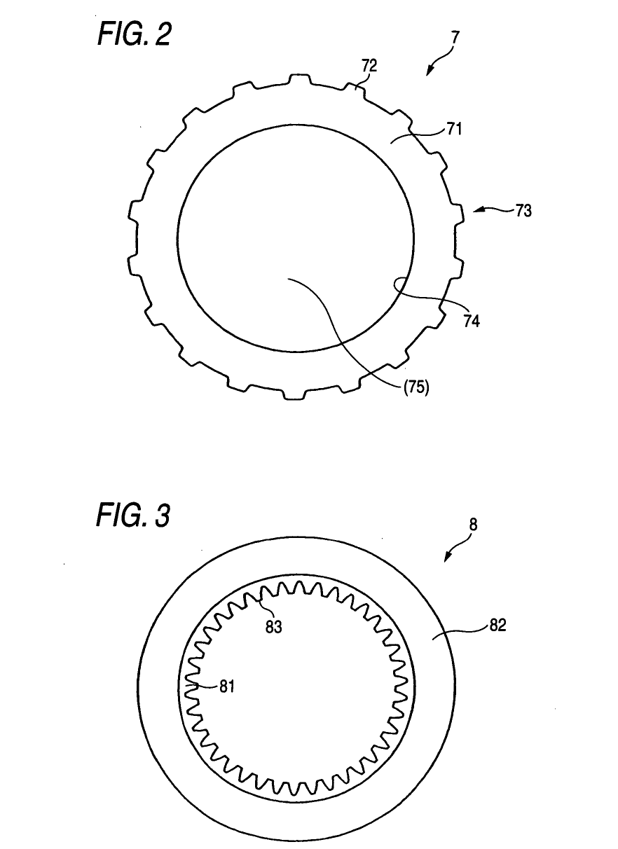

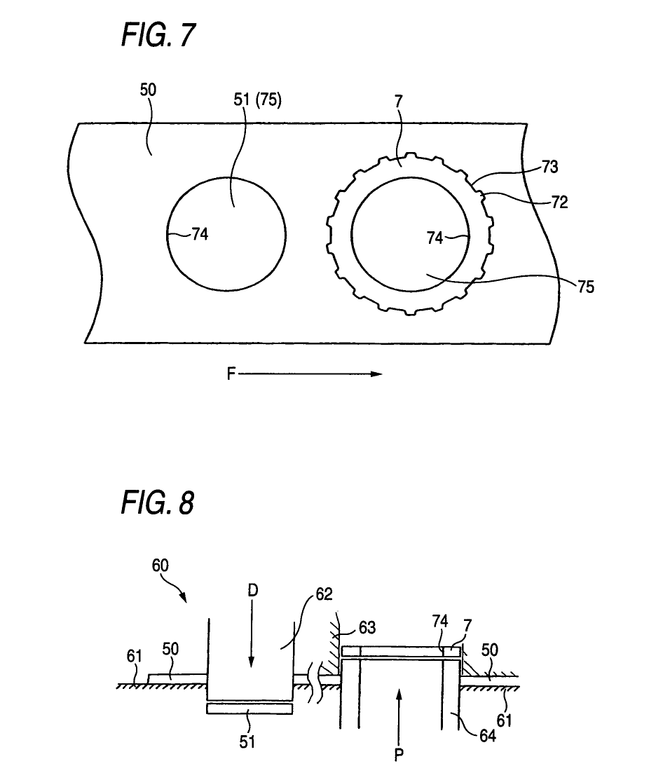

FIG. 7 and FIG. 8 conceptually show a process 60 for manufacturing a separator plate according to the present invention. FIG. 7 is a drawing showing an order in punching a metal plate material 50 which is flowing in direction F. FIG. 8 is a drawing showing how to punch the material, corresponding to FIG. 1.

An example of the way of punching the material is described with reference to FIGS. 7 and 8. A disc type portion 51 is stamped out from the material 50 of a metal plate, which is flowing on a first die 61 in the direction F, by a first punch 62 moving in direction D (from an upper side to a lower side of FIG. 8). As a result, a circular hole 75 having a smooth non-teeth-formed inner circumferential surface 74 is formed on the material 50.

The material 50 advances as the material has the circular hole 75 in the direction F to a subsequent step, in which the material 50 is held between the lower first die 61 and an upper second due 63 and fixed with the circular hole 75 set in the center of the fixed parts. The separator plate 7 is then stamped out by the second punch 64 which moves in the direction P (from the lower side to the upper side of FIG. 8). As a result, a separator plate 7 having spline teeth 72 on the outer circumferential surface 73 thereof is formed.

In the example shown in FIG. 8, the moving directions of the first punch 62 and second punch 64 are set contrary to each other but these directions may be the same. Even when the spline teeth are formed on the inner circumferential surface, the outer circumferential surface may be stamped out first in the same manner, and the spline teeth-formed inner circumferential surface in a subsequent step.

The non-spline-teeth-formed circumferential surface is thus stamped out first, so that the strength of the material to be then stamped out at the spline-teeth-carrying circumferential surface of the separator plate decreases correspondingly. This decrease in the strength of the material is convenient for forming waves in which fine recesses and projections extend continuously along the root circles of the teeth. Moreover, since the distance W defined between the teeth is set larger than the width of one tooth, the generation of the waves becomes further easier.

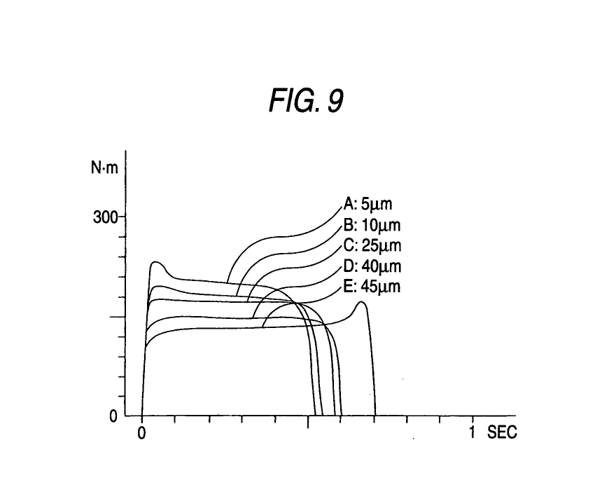

FIG. 9 shows the relation between depth of the waves (which is length in a direction perpendicular to the separator plate) and a waveform of transmission torque occurring during the engagement of the clutch. The time (second) of engagement is taken along the lateral axis, and the transmission torque (N·m) along the longitudinal axis. The conditions for the test included a rotational frequency of 1500 r.p.m., inertial moment of 0.59 kg·m², a pressing load of 3300 N, the fluid temperature of 80±5° C., number of friction surfaces of 10, the outer diameter of the friction surfaces of 99φ, the inner diameter of the same of 73φ, and the depth of the waves concerning the waveforms in the drawing of A around 5 μm, and thereafter in the same manner, B 10 μm, C 25 μm, D 40 μm and E 45 μm.

The results of the test show that the depth of the waves with respect to the waveform A was too small. In this case, the effect was not obtained and the biting torque was large. Concerning the cases B, C and D, the waveform was flat, and good results were obtained. In the case of E, the depth became too large, and the effect of the fluid film in the recessed portion also became too large, so that undesirable results were obtained, i.e., although the transmission torque in the initial period of the engagement of the clutch became small, however, finally the transmission torque becomes suddenly large. The results of the test show that the depth of the waves is preferably 10 to 40 μm.

A wet type multiple disc clutch using the separator plates according to the present invention has a reduced friction coefficient in an initial period of the time of engagement of the clutch, improved frictional characteristics and a shock alleviated during the time of the engagement of the clutch, so that the separator plates are optimally used for automatic transmissions and the like.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A separator plate for wet type multiple disc clutches, comprising:
a ring-shaped plate having an inner circumferential surface and an outer circumferential surface; and
pluralities of spline teeth formed on either the outer circumferential surface or the inner circumferential surface of the plate,
wherein a distance defined between adjacent spline teeth is set not smaller than a width of at least one spline tooth,
a wave is formed by fine recesses and projections projecting in a direction perpendicular to the plate, and
the wave extends continuously along a root circle defined by the spline teeth.

2. The separator plate for wet type multiple disc clutches according to claim 1, wherein a depth in the direction perpendicular to the plate, which is defined by the recesses and the projections of the waves, is 10 to 40 μm.

3. A manufacturing method for a separator plate for wet type clutches comprising pluralities of spline teeth formed on an inner circumferential surface or an outer circumferential surface of the separator plate, the manufacturing method comprising the steps of:
stamping out a non-spline-tooth-formed portion of the separator plate which is an opposite side of a spline-tooth-formed inner circumferential surface thereof or a spline-tooth-formed outer circumferential surface-thereof; and
stamping out the spline tooth-formed portion to thereby form a wave, which is formed by fine recesses and projections, extend continuously along a root circle of the spline tooth after stamping out the non-tooth-formed portion.
